(19) United States
(12) Patent Application Publication
(10) Pub. No.: US 2026/0217574 A1
(43) Pub. Date: Jul. 30, 2026

(54) ELECTROCHEMICAL OXIDATION OF PFAS CONTAMINATED SOLUTIONS

(71) Applicant: Element Six Technologies Limited, Didcot, Oxfordshire (GB)

(72) Inventors: Timothy Peter MOLLART, Didcot, Oxfordshire (GB); Julian James Sargood ELLIS, Didcot, Oxfordshire (GB)

(21) Appl. No.: 19/141,878

(22) PCT Filed: Nov. 22, 2023
(86) PCT No.: PCT/EP2023/082643

§ 371 Date: Jun. 20, 2025

(30) Foreign Application Priority Data
Dec. 23, 2022 (GB) 2219657.0

(51) Int. Cl. C02F 1/467; C02F 1/461; C02F 1/74; C02F 101/36

(52) U.S. Cl. CPC C02F 1/4672; C02F 1/46109; C02F 1/74; C02F 2001/46133; C02F 2101/36

(57) ABSTRACT

A method of electrochemical oxidation of per- and polyfluoroalkyl substances, PFAS, in a solution. The method comprises providing an electrochemical reactor, the electrochemical reactor comprising at least one boron-doped diamond electrode. The PFAS-containing solution is passed over the boron-doped diamond electrode. The electrochemical reactor is operated at a temperature of at least 100° C., a pressure of at least bar, and an electrode current density of at least 1 000 Am−².

### FIELD OF THE INVENTION

The present invention relates to the electrochemical oxidation of per- and polyfluoroalkyl substances (PFAS) in solution, and to electrochemical reactors for the electrochemical oxidation of PFAS in solution.

### BACKGROUND OF THE INVENTION

Per- and polyfluoroalkyl substances (PFAS) are synthetic organofluorine chemical compounds that have multiple fluorine atoms attached to an alkyl chain. FIG. 1 shows an exemplary PFAS chemical structure. Used as precursors to and in fluorocarbons, they have become extremely widespread, from consumer products such as stain projection sprays, ski waxes, non-stick coatings, food packaging, and industrial uses such as fire-fighting foams and chemicals manufacturing. However, PFASs are of increasing environmental concern as their chemical and thermal stability renders traditional waste infrastructure ineffectual at preventing them from reaching the environment. Once in the food chain they are found to bioaccumulate in the fatty tissue of mammals and, via bio-magnification, reach levels where adverse health outcomes can result. In humans PFAS is now linked to diseases including cancers, liver damage, elevated cholesterol levels, infertility, asthma, thyroids conditions and lower immunity. The need to reduce PFAS contamination to the low parts per trillion level is increasing as the scale of contamination and the issues that it causes become clearer.

In the environment, contamination is often linked to manufacturing sites, rubbish incineration plants, spreading of sewage sludge, major fire incidents and fire-fighting training centres such as at airports and military bases. Technology to remediate e.g. drinking water, using separation technology such as reverse osmosis, ion exchange, absorption via activated carbon and nanofiltration are rapidly being developed. However, while these separation stages mitigate human consumption, they can create relatively large volumes of PFAS contaminated reject streams and spent filtration media that may create a significant future legacy contamination if the PFAS compounds are not broken down into their constituent parts. One of the most difficult substances to treat is mature landfill leachate, which is typically a combination of highly recalcitrant dissolved organics, less than 1 000 mg/L to 10 000 mg/L combined with less than 200 mg/L concentrations of PFAS in the range of less than 10 ppm.

Electrochemical advanced oxidation at the surface of boron doped diamond (BDD) is recognised as having the ability to break the carbon fluorine bonds and break down PFAS into the constituent elements emitting e.g. CO₂ gas, fluorine ions and sulphates. While electrochemical processing is more practical than thermal processes such as supercritical water oxidation, where corrosion, energy consumption are seen as drawbacks, however there are a number of concerns over its practicality as a PFAS oxidation technology. Examples of electrochemical reactors that use BDD include WO 2008/029258 and WO 2012/049512.

Schaefer et al. “Electrochemical treatment of perfluorooctanoic acid and perfluorooctanesulfonate: Insights into mechanisms and application to groundwater treatment”, Chemical Engineering Journal 317 (2017) 424-432 describes that several studies have shown that perfluorooctanoic acid (PFOA) oxidation via electrochemical treatment proceeds via a stepwise mechanism in which C—C bond cleavage occurs between the carbon chain and the carboxylate group, coupled with F— elimination. This process is repeated, resulting in the intermediate generation of shorter chain perfluorocarboxylic acids. Consistent with this mechanism, generation of low concentrations of shorter chain perfluorinated carboxylates was observed (perfluorobutanoic acid, perfluoropentanoic acid, perfluorohexanoic acid, and perfluoroheptanoic acid), but at net concentrations of 25% of the total fluorine balance at all times during the experiments. The observation of short chain perfluorinated carboxylates as intermediate products was generally greater in the experiments conducted at low current density, and the generation of these short chain carboxylic acids was up to 50% greater in the presence of chloride.”

Chaplin, B, “The prospect of electrochemical technologies advancing worldwide water treatment”, Acc. Chem. Res. 52(3):596-604 states that BDD film electrodes have been the most promising electrodes for water treatment because of their high anodic stability, high OH· yield, and wide potential window. However, BDD electrodes are typically synthesized using chemical vapor deposition methods, which are slow and expensive and have low production rates. These factors translate to expensive electrodes. It is also difficult to produce high-surface-area BDD electrodes, which results in the use of numerous expensive electrodes to achieve a given treatment objective. Chaplin further suggests that that Ti₄O₇ electrodes are comparable to BDD electrodes for efficiency of organic compound oxidation, and nonoptimized, lab-scale Ti₄O₇ electrodes can be synthesized at much lower costs. The lower costs relative to BDD are due to the much higher specific surface area of porous Ti₄O₇ electrodes relative to BDD electrodes, and so Chaplin suggests that Ti₄O₇ may be an appropriate electrode material from both a technical and economic standpoint.

Poor mass transport for the PFAS to an active proximity of the electrode results in inefficient electrochemical oxidation, with much of the electrode area and electrical energy being wasted on electrolysis of water rather than PFAS oxidation. PFAS is only broken down at the electrode surface, as the low ppm concentration species need to be in within nanometres of the BDD electrode surface. Even the hydroxyl radical is only formed at the surface of the BDD and reacts within <20 nm of the surface and has a lifetime of less than 10 ns. At 200 mg/L to 0 mg/L PFAS oxidation is less than 15% efficient in commercial electrochemical reactors. Since PFAS molecules are extremely recalcitrant and hydrophobic, short chain PFAS incineration is likely to be even less efficient. At 1 000 mg/L low current efficiency is somewhat mitigated by operating at lower current density, however a factor of 10 reduction in current density only results in a marginal 5% increase in current efficiency to <20%, which would come at a significant increase in the capital cost.

When low ppm contamination of PFAS is combined with other dissolved organics in an electrochemical system, PFAS treatment becomes more difficult as direct oxidation at the electrode surface of PFAS competes against indirect oxidation of the other species and real-world treatment systems often struggle to be effective at eliminating PFAS to the desired levels. This results in high electrical power consumption costs as the work done to oxidise this effluent is high. In other words, the presence of other dissolved organics makes PFAS removal more expensive, which points towards wanting to avoid combining both in a solely electrochemical approach. Overall, there is a concern that BDD is too expensive for PFAS treatment which is mainly related to an awareness of the need for a very large area and the cost of ownership of the BDD electrode.

### SUMMARY

There are several ways to address the problems discussed above. One way is to develop methods for improving the mass transport to the surface, for example by increasing the surface area of the BDD electrodes via an increase in porosity. Another way is by treating dissolved organics that could otherwise cause high erosion rates for BDD and by operating a higher temperatures and pressures significantly reduce the power consumption of the electrochemical process. A two stage or hybrid oxidation process could be used that further improves the efficiency of PFAS oxidation by reducing less recalcitrant contaminants by other means.

According to a first aspect of the invention, there is provided a method of electrochemical oxidation of per- and polyfluoroalkyl substances, PFAS, in a solution. The method comprises providing an electrochemical reactor, the electrochemical reactor comprising at least one boron-doped diamond electrode. The PFAS-containing solution is passed over the boron-doped diamond electrode. The electrochemical reactor is operated at a temperature of at least 100° C., a pressure of at least 5 bar, and an electrode current density of at least 1 000 Am⁻². These conditions optimise the electrochemical oxidation of PFAS-containing solutions and other less recalcitrant species are oxidised thermally.

As an option, the electrochemical reactor comprises a plurality of boron-doped diamond electrodes.

As an option, the boron-doped diamond electrode is a monolithic, unbacked boron-doped diamond electrode.

Boron-doped electrodes erode much slower than other types of electrode, thereby giving the electrochemical reactor a longer working life, reducing contaminated waste and a lower cost of ownership. For a given effluent and electrolyte system the lifetime of a BDD electrode can be evaluated by measuring the amount of diamond lost in a >50 hour experiment at a series of current densities and the resulting linear fit gives the erosion gradient. This can then be used to calculate when the BDD is consumed. In PFAS effluents as an option, the boron-doped diamond electrode has an erosion gradient of less than 0.0025 nmh⁻¹ Am².

As an option, the method comprises operating the electrochemical reactor at a temperature selected from any of at least 120° C. and at least 220° C.

As an option, the method comprises operating the electrochemical reactor at a pressure selected from any of at least 10 bar and at least 20 bar.

As an option, the method comprises operating the electrochemical reactor at an electrode current density selected from any of at least 2 000 Am⁻², at least 5 000 Am⁻²; and at least 10 000 Am⁻².

The conductivity of the solution can affect the efficiency of electrochemical oxidation. As an option, the conductivity of the solution is selected from any of at least 5 000 μScm⁻¹; at least 10 000 μScm⁻¹; and at least 20 200 μScm⁻¹.

The solution optionally further comprises a supporting electrolyte. As a further option, the supporting electrolyte comprises sodium hydroxide.

The method optionally further comprises injecting air into the solution to facilitate low temperature oxidation of non-recalcitrant dissolved organics

As an option, the method further comprises adding a polar aprotic solvent to the solution. As a further option, the polar aprotic solvent comprises any of dimethyl sulfoxide, DMSO and dimethyl carbonate, DMCO.

The method optionally further comprising adding sulfate ions to the solution to create persulfates.

As an option, the method comprises applying wet air oxidation to the solution. Wet air oxidation can be applied in situ in the electrochemical cell, and assists in oxidising non-PFAS species in the solution.

The method optionally further comprises, prior to electrochemical oxidation, performing a separation operation on the PFAS-containing solution. This ensures that a more concentrated PFAS solution can be passed over the electrode, thereby making the electrochemical oxidation more efficient. As a further option, the separation operation comprises any of forming a foam from the solution and separating the foam from the solution; and using a condensing column to remove volatile short-chain PFAS from the solution.

As an option, the boron-doped diamond electrode is selected from any of a CVD boron doped diamond electrode, an HPHT boron doped diamond electrode, and a boron doped diamond electrode formed from hot compacted boron doped diamond grit.

According to a second aspect, there is provided a method of electrochemical oxidation of per- and polyfluoroalkyl substances, PFAS, in a solution. The method comprises providing an electrochemical reactor, the electrochemical reactor comprising at least one boron-doped diamond electrode. The PFAS-containing solution is passed over the boron-doped diamond electrode. The electrochemical reactor is operated at an electrode current density of at least 5 000 Am⁻².

As an option, the electrochemical reactor comprises a plurality of boron-doped diamond electrodes.

As an option, the boron-doped diamond electrode is a monolithic, unbacked boron-doped diamond electrode.

As an option, the method comprises operating the electrochemical reactor at a temperature selected from any of at least 100° C., at least 120° C. and at least 220° C.

As an option, the method comprises operating the electrochemical reactor at a pressure selected from any of at least 5 bar, at least 10 bar, and at least 20 bar.

As an option, the method comprises operating the electrochemical reactor at an electrode current density at least 10 000 Am⁻².

The conductivity of the solution can affect the efficiency of electrochemical oxidation. As an option, the conductivity of the solution is selected from any of at least 5 000 μScm⁻¹; at least 10 000 μScm⁻¹; and at least 20 000 μScm⁻¹.

The solution optionally further comprises a supporting electrolyte. As a further option, the supporting electrolyte comprises sodium hydroxide.

The method optionally further comprises injecting air into the solution to facilitate low temperature oxidation of non-recalcitrant dissolved organics

As an option, the method further comprises adding a polar aprotic solvent to the solution. As a further option, the polar aprotic solvent comprises any of dimethyl sulfoxide, DMSO and dimethyl carbonate, DMCO.

The method optionally further comprising adding sulfate ions to the solution to create persulfates.

As an option, the method comprises applying wet air oxidation to the solution. Wet air oxidation can be applied in situ in the electrochemical cell, and assists in oxidising non-PFAS species in the solution.

The method optionally further comprises, prior to electrochemical oxidation, performing a separation operation on the PFAS-containing solution. This ensures that a more concentrated PFAS solution can be passed over the electrode, thereby making the electrochemical oxidation more efficient. As a further option, the separation operation comprises any of forming a foam from the solution and separating the foam from the solution; and using a condensing column to remove volatile short-chain PFAS from the solution.

As an option, the boron-doped diamond electrode is selected from any of a CVD boron doped diamond electrode, an HPHT boron doped diamond electrode, and a boron doped diamond electrode formed from hot compacted boron doped diamond grit.

According to a third aspect, there is provided an electrochemical reactor configured for electrochemical oxidation of per- and polyfluoroalkyl substances, PFAS, in a solution. The electrochemical reactor comprises at least one boron-doped diamond electrode, a channel for passing the PFAS-containing solution over the at least one boron-doped diamond electrode, and a heat source configured to maintain a temperature at least 100° C. in the electrochemical reactor. The electrochemical reactor is configured to operate at a pressure of at least 5 bar, and the boron-doped diamond electrode is configured to operate at a current density of at least 1 000 Am⁻².

The electrochemical reactor optionally further comprises a plurality of boron-doped diamond electrodes.

As an option, the boron-doped diamond electrode is a monolithic, unbacked boron-doped diamond electrode.

The heat source is optionally configured to maintain a temperature selected from any of at least 120° C. and at least 220° C.

The electrochemical reactor is optionally configured to operate at a pressure selected from any of at least 10 bar, and at least 20 bar.

The boron-doped diamond electrode is optionally configured to operate at a current density selected from any of at least 2 000 Am⁻², at least 5 000 Am⁻²; and at least 10 000 Am⁻².

As an option, the electrochemical reactor further comprises means for injecting air into the solution to facilitate low temperature oxidation of non-recalcitrant dissolved organics

As an option, the heat source is the PFAS-containing solution which may heat up when an electric field is applied using the electrode.

According to a fourth aspect, there is provided an electrochemical reactor configured for electrochemical oxidation of per- and polyfluoroalkyl substances, PFAS, in a solution. The electrochemical reactor comprises at least one boron-doped diamond electrode, a channel for passing the PFAS-containing solution over the at least one boron-doped diamond electrode. The electrochemical reactor is configured to operate at a current density of at least 1 000 Am⁻².

As an option, the electrochemical reactor is configured to operate at a current density of at least 2 000 Am⁻², at least 5 000 Am⁻², or at least 10 000 Am⁻².

### BRIEF DESCRIPTION OF THE DRAWINGS

Some embodiments of the invention will now be described by way of example only and with reference to the accompanying drawings, in which:

FIG. 1 shows an exemplary PFAS chemical structure;

FIG. 2 illustrates schematically in a block diagram an exemplary electrochemical reactor;

FIG. 3 illustrates schematically in a block diagram an exemplary hybrid system for oxidising solutions containing PFAS;

FIG. 4 is a flow diagram illustrating steps for an exemplary system for separation and subsequent oxidation of solutions containing PFAS;

FIG. 5 is a flow diagram illustrating steps for electrochemical oxidation of PFAS using the electrochemical reactor of FIG. 2; and

FIG. 6 is a flow diagram illustrating alternative steps for electrochemical oxidation of PFAS using the electrochemical reactor of FIG. 2.

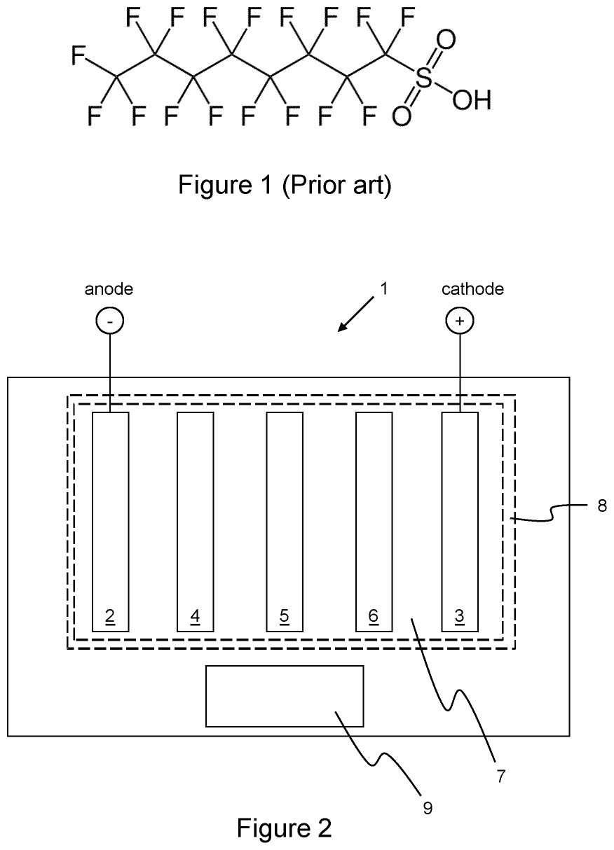

### DETAILED DESCRIPTION

An exemplary reactor that uses boron dope diamond (BDD) electrodes is described in WO 2008029258. The reactor described therein has an acrylic container that holds an electrolyte and three solid diamond bipolar electrodes spaced apart and disposed parallel to each another. The bipolar electrodes are located between and anode and a cathode. In an example given, the electrolyte is waste water, to which salts may be added to ensure electrical conductivity. In use, a potential difference is applied between the anode and the cathode.

The type of reactor described in WO 20080829258 is quite simple, and subsequent developments include electrochemical reactors that can be operated at higher temperatures and pressures. However, the basic principle remains the same. FIG. 2 illustrates schematically in a block diagram an exemplary electrochemical reactor 1. The electrochemical reactor 1 has an anode 2 and a cathode 3, which may be formed from BDD. Three bipolar electrodes 4, 5, 6 are disposed between the anode 2 and the cathode 3. Channels 7 pass between the electrodes and in use a PFAS-containing solution is passed through the channels in proximity to the electrodes. One or more seals 8 ensure the channels can operate at elevated pressure. A heater source may be 9 provided that allows the temperature of the PFAS-containing solution to be elevated. This may be provided as a separate heat source, but note that the heat source may be the combination of the PFAS-containing solution and the applied electrical power. It will be appreciated that the PFAS-containing solution has some resistivity, and so when applying electrical power to effect electrochemical oxidation, some of the applied power is dissipated as heat.

In a first exemplary embodiment, a combination of electrochemical oxidation and wet air oxidation is used to improve the efficiency of oxidation of a PFAS in a solution.

As described above, poor mass transport for the PFAS to an active proximity of the electrode results in inefficient electrochemical oxidation. This means that a significant amount of power is spent inefficiently in electrolysis of the solute rather than the PFAS. It has now been found that power consumption can be reduced by operating at higher temperatures and pressures. Previous work has shown operation up to 55° C. and 3.45 bar pressure can reduce power consumption, as described in U.S. Pat. No. 10,618,03.

Surprisingly, it has been found that operating pressures and temperatures can be pushed much higher, for example by using polyether ether ketone (PEEK) bodies and Invar-backed end electrodes to support the BDD electrode pressure differential.

Operating the electrochemical reactor at elevated pressure and temperature, in addition to reducing the operating voltage required via increased conductivity of the PFAS-containing solution, also improves the efficiency of the electrochemical oxidation process for the following reasons:

Higher pressures and temperatures reduce the formation of bubbles which allows more of the PFAS-containing solution to be in contact with the electrodes and reduces their volume and increases the efficiency of the electrochemical oxidation process.

Mass transport of the PFAS-containing solution is increased at higher temperatures.

It enables a thermal oxidation process by combining a low to medium temperature and pressure wet air oxidation process with the electrochemical process, thereby significantly improving the overall efficiency of oxidation system.

The term PFAS encompasses several thousand compounds of various compositions and polymer chain lengths. In electrochemical treatment processes, de-fluorination is believed to take place by breaking the compounds into progressively shorter chain PFAS species, for example from perfluorooctanoic acid (PFOA) into perfluorobutanoic acid (PFBA), perfluoropentanoic acid (PFPeA), perfluorohexanoic acid (PFHxA) and perfluoroheptanoic acid PFHpA. These shorter chained PFAS compounds are harder to break down in an oxidation process, and in treatment systems these can reside and build up in concentration. It has been found that increasing the intensity of the electrochemical oxidation process at the surface of the electrode via increasing the current density reduces the formation of short chain PFAS compounds, and can also be used to mineralise into fluorine ions and carbon dioxide. Operation at current density of <5 000 Am⁻² increases oxidation to a point where short chain PFAS can be eliminated.

In a first exemplary embodiment, an electrochemical cell is operated at elevated temperatures and pressures in a process that is combined with wet air oxidation. Operating pressures of around 30 bar and operating temperatures of between 200 and 240° C. are within the defined regime for medium pressure wet air oxidation treatment processes. Wet air oxidation is a process in which aqueous waste is oxidized in the liquid phase at elevated temperatures and pressures in the presence air (or less typically, another oxygen-containing gas). An exemplary wet air oxidation process is described in US2019160452.

A combination of wet air oxidation and an electrochemical reactor using BDD electrodes reduces the power required to electrochemically oxidise PFAS because the wet air oxidation oxides other organic species in the solution that would otherwise require electrical power to oxidise electrochemically.

Finite element modelling of materials used in existing electrochemical reactors, such as PEEK, VITON™ fluoroelastomers, and Invar, suggest that pressures of up to 20 Bar and temperatures of 130° C. are feasible for extended use of an electrochemical reactor.

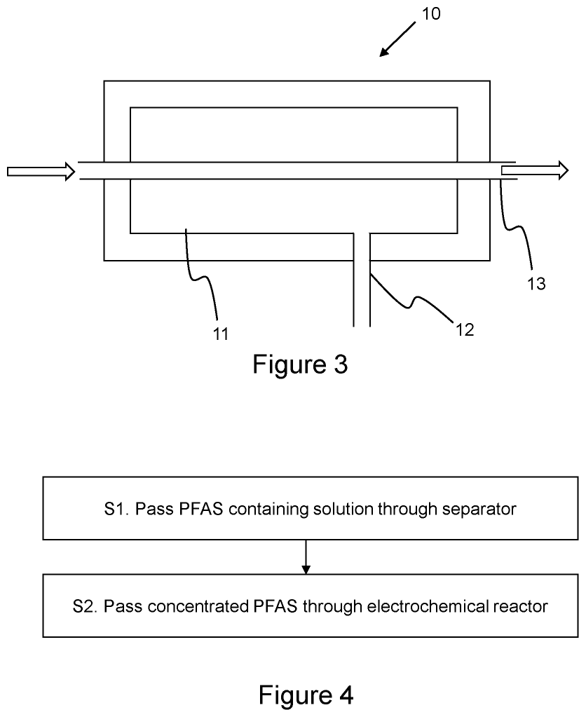

FIG. 3 illustrates schematically in a block diagram an exemplary hybrid system 10 for oxidising PFAS. The hybrid system includes an electrochemical reactor 11 that also has an access port 12 for an oxidant such as air to perform wet air oxidation. The electrochemical oxidation raises the fluid to a temperature suitable for wet air oxidation A channel 13 for a solution containing PFAS passes. Note that while the wet air oxidation unit 11 and electrochemical reactor 12 are illustrated separately, the wet air oxidation process is carried out directly in the electrochemical reactor 12.

In a second exemplary embodiment, electrochemical oxidation is carried out at temperatures around 120° C. in the presence of sodium hydroxide and polar aprotic solvents. Trang et al, “Low-temperature mineralization of perfluorocarboxylic acids”, https://www.science.org/doi/10.1126/science.abm8868, claims that “Heating PFAS with sodium hydroxide to 80-120° C. in a water/dimethyl sulfoxide mixture first removes the molecules'carboxylic acid head groups, leaving behind a reactive perfluoroalkyl ion tail. Within 24 hours, it further degrades to fluoride ions and small carbon-containing ions such as formate and carbonate.”

Examples of polar aprotic solvents include dimethyl sulfoxide (DMSO) and dimethyl carbonate (DMCO). DMSO is an organosulfur compound with the formula (CH₃)₂SO, and is similar to DMCO, which has been found to have a low erosion rate. Cost may be the deciding factor in whether or not to use DMSO or DMCO.

Whichever polar aprotic solvent is used, carrying out electrochemical oxidation of a PFAS containing solution in the presence of sodium hydroxide and polar aprotic solvents improves the efficiency of oxidation.

In a third exemplary embodiment, a separation process is carried out prior to electrochemical oxidation. One of the key uses of PFAS compounds is in firefighting foams. PFAS compounds have a propensity to foam and short chain PFAS can become volatile. Electrochemical oxidation at elevated pressures and temperatures can exploit the propensity to foam by separating the foam prior to oxidation, or by exploiting the volatility of short chain PFAS by the use of a condensing column to separate more volatile species in an expansion tank or column prior to oxidation.

Either of these separation techniques allows a more concentrated solution to be passed through the electrochemical reactor, thereby increasing the efficiency of electrochemical oxidation.

Referring to FIG. 4 herein, there is shown a flow diagram illustrating steps for an exemplary system for separation and subsequent oxidation of solutions containing PFAS. The following numbering corresponds to that of FIG. 4:
S1. A PFAS-containing solution is passed through a separator. As described above, this may be by foaming the solution and separating the foam, or by the use of a condensing column. This creates a concentrated PFAS solution.
S2. The concentrated PFAS is passed into an electrochemical reactor for electrochemical oxidation of the PFAS.

In a fourth exemplary embodiment, electrochemical oxidation is enhanced with UV illumination. Electrochemical oxidation with BDD electrodes requires there to be a supporting electrolyte to provide ions that are able to transport current to the electrodes. There are limited choices for electrolytes, mainly driven by cost and compatibility with drinking water applications. For example, the use of halide salts is limited by the formation of perchlorates and bromides, which themselves are hazardous contaminates.

In PFAS removal, rates are shown to increase when sulphate electrolytes are used, where it is speculated that persulphates perform oxidation in the solution, effectively enhancing mass transport. Advanced oxidation using UV illumination can be used to treat some PFAS and or other dissolved organics. It is observed that hydrogen peroxide production rates/current efficiency increases in the presence of carbonate species that are able to form percarbonate species (a radical) which after reactions in the solution phase are reacted at the electrode surface. An increase in current efficiency of around two times has been observed. A potential approach solution for PFAS oxidation is a hybrid approach where carbonates are used as the supporting electrolyte to promote hydrogen peroxide production and UV illumination is used to drive a hydrogen peroxide UV advanced oxidation process.

Furthermore, increasing the porosity of the BDD electrodes increases the effective surface area of the BDD electrodes and therefore increases the efficiency of PFAS oxidation. This may be done in CVD BDD electrodes by, for example, laser machining holes in the surface of the BDD electrode. It is known that nickel etching can also create porosity in BDD electrodes. This type of process can be used to create a porous electrode structure for a cell. In combination with the use of bipolar electrodes between an anode and a cathode, the PFAS-containing solution can be passed through the electrodes rather than just over the surface. Gas bubbles are minimised by operating at ultra-high pressures.

Furthermore, improvements to the efficiency of oxidation of PFAS-containing solvents can be made by engineering or selecting suitable electrodes. BDD grits can be formed in a high-pressure high-temperature (HPHT) process rather than by CVD, see for example GB2582942 and WO2020207978. Such electrodes have been found to have a much higher capacitance than CVD electrodes, which is indicative of a higher surface area and higher porosity. The electrodes can be engineering to increase the porosity further by selecting suitable process parameters during manufacture or by post-synthesis acid leaching to create a network of pores in the electrode. This gives permeable access to the electrode and effectively increases the surface area of the electrode, thereby increasing the efficiency of PFAS oxidation.

A problem with boron doped diamond electrodes in PFAS oxidation is that they erode. This is a much slower process than erosion of metal electrodes, but is still an issue. It has been found that the addition of around 100 ppm of PFAS in 1 M NaSO₄ halves the erosion rate compared to 1 M NaSO₄ alone and has an erosion rate of around a thirtieth of the rate of 100 ppm of acetic acid in 1 M NaSO₄. Careful selection of the chemistry of the PFAS-containing solution can therefore greatly prolong the life of the BDD electrodes.

Finally, when dealing with PFAS contamination, even very low concentrations of PFAS can be a problem. The electrochemical reactor design can selected to minimise the risk of any PFAS compounds leaking into the solution from the electrochemical reactor components. For example, some reactors may contain polytetrafluoroethylene (PTFE) parts and Viton fluoropolymer O-rings that can shed PTFE into the solution. These parts can be eliminated where ultra-high purity is required. However, the replacement parts must still be able to operate at a temperature of at least 100° C. and a pressure of at least 5 bar. For example, ceramic parts may be used as spacers, posts and gasket seals.

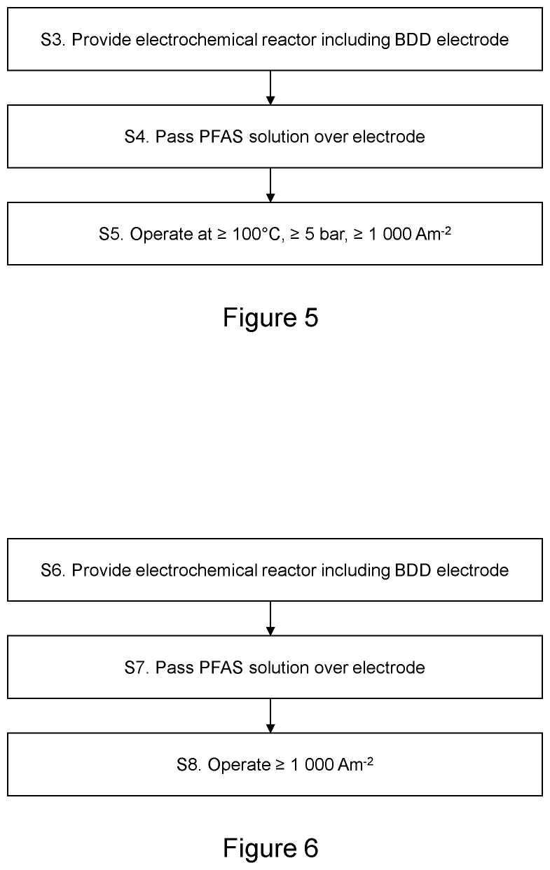

FIG. 5 is a flow diagram illustrating steps for electrochemical oxidation of PFAS using the electrochemical reactor of FIG. 2. The following numbering corresponds to that of FIG. 5:
S3. An electrochemical reactor is provided that includes at least one BDD electrode. Typically, it will include several BDD electrodes, some of which may be bipolar, and some of which may be monolithic, unbacked electrodes. Different types of electrode may be suitable as discussed above. For example, CVD boron doped diamond electrodes, HPHT boron doped diamond electrodes, and boron doped diamond electrodes formed from hot compacted boron doped diamond grit may be used.
S4. A PFAS-containing solution is passed over the boron-doped diamond electrode. The conductivity of the solution may be at least 5 000 μScm⁻¹, at least 10 000 μScm⁻¹, or at least 20 000 μScm⁻¹. A supporting electrolyte such as sodium hydroxide may be added to the solution. Air may be injected into the solution to facilitate low temperature oxidation of non-recalcitrant dissolved organics. Furthermore, a polar aprotic solvent may be added to the solution. Examples of a polar aprotic solvent include DMSO and DMCO.
S5. The electrochemical reactor is operated at a temperature of at least 100° C., or at least 120° C. or at least 220° C. Furthermore, it is operated at a pressure of at least 5 bar, or at least 10 bar or at least 20 bar. It is further operated at an electrode current density of at least 1 000 Am⁻², or at least 2 000 Am⁻², or at least 5 000 Am⁻², or at least 10 000 Am⁻².

FIG. 6 is a flow diagram illustrating alternative steps for electrochemical oxidation of PFAS using the electrochemical reactor of FIG. 2. The following numbering corresponds to that of FIG. 6:
S6. An electrochemical reactor is provided that includes at least one BDD electrode. Typically is will include several BDD electrodes, some of which may be bipolar, and some of which may be monolithic, unbacked electrodes. Different types of electrode may be suitable as discussed above. For example, CVD boron doped diamond electrodes, HPHT boron doped diamond electrodes, and boron doped diamond electrodes formed from hot compacted boron doped diamond grit may be used.
S7. A PFAS-containing solution is passed over the boron-doped diamond electrode.
S8. The electrochemical reactor is operated at an electrode current density of at least 5 000 Am⁻².

Several embodiments have been described above that can improve the efficiency of oxidation of a PFAS-containing solution. Each embodiment may be used in combination with one or more of the other embodiments.

While this invention has been particularly shown and described with reference to embodiments, it will be understood by those skilled in the art that various changes in form and detail may be made without departing from the scope of the invention as defined by the appended claims.

1. A method of electrochemical oxidation of per- and polyfluoroalkyl substances, PFAS, in a solution, the method comprising:
providing an electrochemical reactor, the electrochemical reactor comprising at least one boron-doped diamond electrode;
passing the PFAS-containing solution over the boron-doped diamond electrode; and
operating the electrochemical reactor at a temperature of at least 100° C., a pressure of at least 5 bar, and an electrode current density of at least 1000 Am⁻².

2. The method according to claim 1, wherein the electrochemical reactor comprises a plurality of boron-doped diamond electrodes.

3. The method according to claim 1, wherein the boron-doped diamond electrode is a monolithic, unbacked boron-doped diamond electrode.

4. (canceled)

5. The method according to claim 1, further comprising operating the electrochemical reactor at a temperature selected from any of at least 120° C. and at least 220° C. and at a pressure selected from any of at least 10 bar and at least 20 bar.

6. (canceled)

7. The method according to claim 1, further comprising operating the electrochemical reactor at an electrode current density selected from any of at least 2 000 Am⁻², at least 5 000 Am⁻²; and at least 10 000 Am⁻².

8. The method according to claim 1, wherein the conductivity of the solution is selected from any of at least 5 000 μScm⁻¹, at least 10 000 μScm⁻¹; and at least 20 000 μScm⁻¹.

9. The method according to claim 1, wherein the solution further comprises a supporting electrolyte.

10. (canceled)

11. The method according to claim 1, further comprising injecting air into the solution to facilitate low temperature oxidation of non-recalcitrant dissolved organics

12. The method according to claim 1, further comprising adding a polar aprotic solvent to the solution.

13. (canceled)

14. The method according to claim 1, further comprising adding sulfate ions to the solution to create persulfates.

15. The method according to claim 1, further comprising applying wet air oxidation to the solution.

16. The method according to claim 1, further comprising, prior to electrochemical oxidation, performing a separation operation on the PFAS-containing solution.

17. (canceled)

18. (canceled)

19. A method of electrochemical oxidation of per- and polyfluoroalkyl substances, PFAS, in a solution, the method comprising:
providing an electrochemical reactor, the electrochemical reactor comprising at least one boron-doped diamond electrode;
passing the PFAS-containing solution over the boron-doped diamond electrode; and
operating the electrochemical reactor at an electrode current density of at least 5 000 Am⁻².

20. An electrochemical reactor configured for electrochemical oxidation of per- and polyfluoroalkyl substances, PFAS, in a solution, the electrochemical reactor comprising:
at least one boron-doped diamond electrode;
a channel for passing the PFAS-containing solution over the at least one boron-doped diamond electrode;
a heat source configured to maintain a temperature of at least 100° C. in the electrochemical reactor;
wherein the electrochemical reactor is configured to operate at a pressure of at least 5 bar, and the boron-doped diamond electrode is configured to operate at a current density of at least 1 000 Am⁻².

21. The electrochemical reactor according to claim 20, further comprising a plurality of boron-doped diamond electrodes.

22. (canceled)

23. The electrochemical reactor according to claim 20, wherein the heat source is configured to maintain a temperature selected from any of at least 120° C. and at least 220° C. and the electrochemical reactor is configured to operate at a pressure selected from any of at least 10 bar, and at least 20 bar.

24. (canceled)

25. (canceled)

26. The electrochemical reactor according to claim 20, further comprising means for injecting air into the solution to facilitate low temperature oxidation of non-recalcitrant dissolved organics

27. The electrochemical reactor according to claim 20, wherein the heat source is the PFAS-containing solution.

28. An electrochemical reactor configured for electrochemical oxidation of per- and polyfluoroalkyl substances, PFAS, in a solution, the electrochemical reactor comprising:
at least one boron-doped diamond electrode;
a channel for passing the PFAS-containing solution over the at least one boron-doped diamond electrode;
wherein the electrochemical reactor is configured to operate at a current density of at least 1 000 Am⁻².

29. (canceled)
